(19) United States
(12) Patent Application Publication
(10) Pub. No.: US 2006/0092171 A1
(43) Pub. Date: May 4, 2006

(54) Method and system for image white point estimation

(76) Inventor: Xuemei Zhang, Mountain View, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/979,856

(22) Filed: Nov. 1, 2004

(51) Int. Cl. G09G 5/02

(52) U.S. Cl. 345/589

(57) ABSTRACT

Difference values between selected pixels pairs in the same color plane are determined for each color plane of an image. The pixel pairs may include contiguous or non-contiguous pixels. A statistic based on the pixel difference values of each color plane is then used to estimate the white point.

### BACKGROUND

Different types of light sources affect how the colors in a scene are captured by a digital device, such as a digital camera or scanner. A light source that emits warm-colored light, such as a tungsten light, causes different illuminant-dependent color changes than a light source that emits cool-colored light. If left untreated, illuminant-dependent color changes can result in objectionable color casts in the captured image.

To reduce the effects of light sources in an image, systems employ white balance or illuminant correction when processing a captured image. White balance is typically a two step process. The first step involves white point estimation, where the spectrum of the illuminants in a scene or image is estimated. Alternatively, some systems perform white point estimation by determining the response of the digital device to a white surface in the scene.

The second step adjusts the color values in the image based on the estimated white point. Color adjustments may be accomplished using one of several techniques. One technique performs an independent scaling of pixels values in the sensor color space. Another technique applies a different linear 3×3 transformation for each identified illuminant.

Regardless of the technique used for color adjustments, the efficacy of the adjustments is impacted by the accuracy of the white point estimation. Object colors in an image appear more consistent to the human eye when the white point estimation closely represents the color values of a white surface in the image. The effects of the different illuminants in a scene are reduced when white balancing is based on more precise white point estimation.

### SUMMARY

In accordance with the invention, a method and system for image white point estimation are provided. Difference values between selected pixels pairs in the same color plane are determined for each color plane of an image. The pixel pairs may include contiguous or non-contiguous pixels. A statistic based on the pixel difference values of each color plane is then used to estimate the white point.

### BRIEF DESCRIPTION OF THE DRAWINGS

The invention will best be understood by reference to the following detailed description of embodiments in accordance with the invention when read in conjunction with the accompanying drawings, wherein:

FIG. 1 illustrates a flowchart of a first method for image white point estimation in an embodiment in accordance with the invention;

FIGS. 2A-2B depict a flowchart of a second method for image white point estimation in an embodiment in accordance with the invention;

FIG. 3 is a block diagram of a system that may be used to implement the methods of FIG. 1 and FIG. 2; and

FIG. 4 is a graphical illustration of an image that is used to demonstrate the white point estimation methods of FIG. 1 and FIG. 2.

### DETAILED DESCRIPTION

The following description is presented to enable one skilled in the art to make and use embodiments in accordance with the invention, and is provided in the context of a patent application and its requirements. Various modifications to the disclosed embodiments will be readily apparent to those skilled in the art, and the generic principles herein may be applied to other embodiments. Thus, the invention is not intended to be limited to the embodiments shown, but is to be accorded the widest scope consistent with the appended claims and with the principles and features described herein.

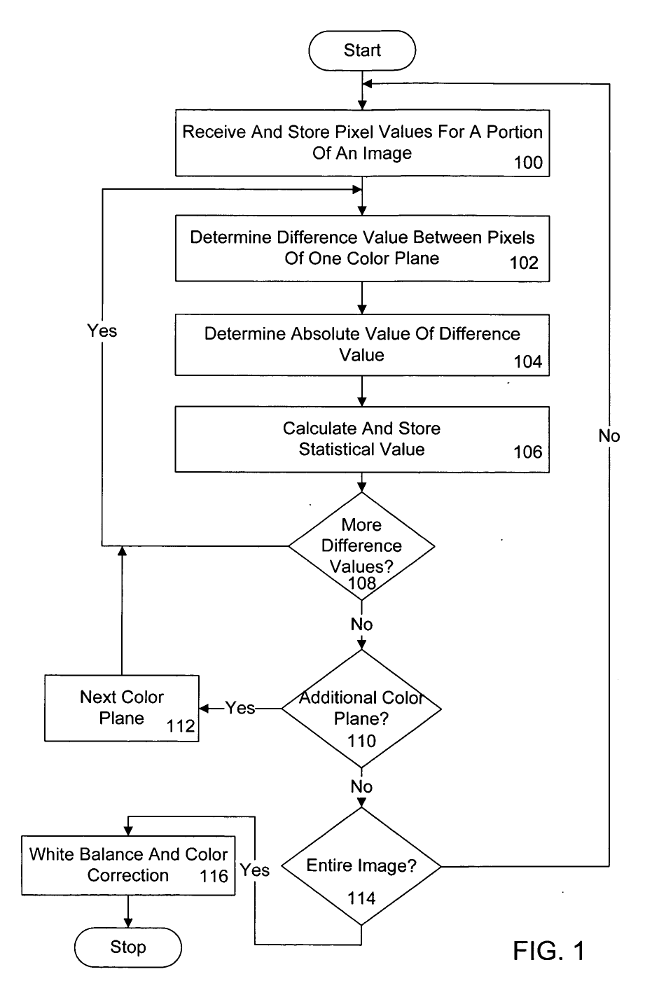

With reference to the figures and in particular with reference to FIG. 1, there is shown a flowchart of a first method for image white point estimation in an embodiment in accordance with the invention. The embodiment of FIG. 1 assumes a single consistent illuminant for the entire image. Other embodiments in accordance with the invention, however, are not limited to this assumption. When two or more spatially color-variant illuminants are present in an image, for example, embodiments in accordance with the invention may perform the method of FIG. 1 on sub-regions within the image to estimate each illuminant separately.

Initially the pixel values for a portion of an image are received, as shown in block 100. A difference value between two selected pixels in one color plane is then determined (block 102). For example, in one embodiment in accordance with the invention, each pixel in an image includes red, green, and blue color values. A difference value between two pixels in one of the three planes, such as, for example, the red plane, is determined at block 102.

The difference value may be represented by the equation (A_{λ1}−A′_{λ1}), where A_{λ1} equals the surface reflectance at wavelength λ for one pixel and A′_{λ1} represents the surface reflectance at the same wavelength for the other pixel. In one embodiment in accordance with the invention, the difference value is calculated between two horizontally contiguous pixels. In another embodiment in accordance with the invention, two vertically contiguous pixels are used to determine a difference value. Other embodiments in accordance with the invention may use pixels positioned anywhere within the image to calculate a difference value.

Next, at block 104, the absolute value of the difference value is obtained. The equation (A_{λ1}−A′_{λ1}) therefore becomes |(A_{λ1}−A′_{λ1})|. The absolute difference value is then included in a statistic of absolute difference values for the pixels in the same color plane. The statistic is also stored in a memory, as shown in block 106.

In the embodiment of FIG. 1 the statistic is implemented as an average of absolute difference values for the pixels in the same color plane. The equation |\overline{x−x′}| represents an average of the absolute difference values, with x representing a color value of one pixel and x′ the color value of the other pixel. For example, x and x′ may represent the red, green, or blue color values for two pixels in a RGB color image. In other embodiments in accordance with the invention, the statistic may be implemented with other types of statistics, such, as, for example, squared differences, medians, or pixel differences on multiple resolution scales.

A determination is then made at block 108 as to whether additional difference values need to be calculated for selected pixels in the one color plane. If so, the process returns to block 102 and continues until all desired difference values have been determined for the selected pixels in the same color plane. When all desired difference values have been determined for the selected pixels in the same color plane, a determination is made at block 110 as to whether there is another color plane to analyze. If so, the method moves to the next color plane at block 112. The method then returns to block 102 where selected pixels in the next color plane are processed.

When all desired difference values have been determined for selected pixels in all color planes, a determination is made at block 114 as to whether the entire image has been processed. If not, the method returns to block 100 and repeats until the entire image is processed. When the entire image has been analyzed, the final computed averages of the absolute difference values, |\overline{r−r′}|, |\overline{g−g′}|, and |\overline{b−b′}|, are used to estimate the white point in one embodiment in accordance with the invention. In another embodiment in accordance with the invention, the averages of the absolute difference values are compared with values associated with known illuminants in order to determine the illuminant type, and the white point for the known illuminant is used in white point estimation. White balance and color correction are then performed using these white point estimation values (block 116).

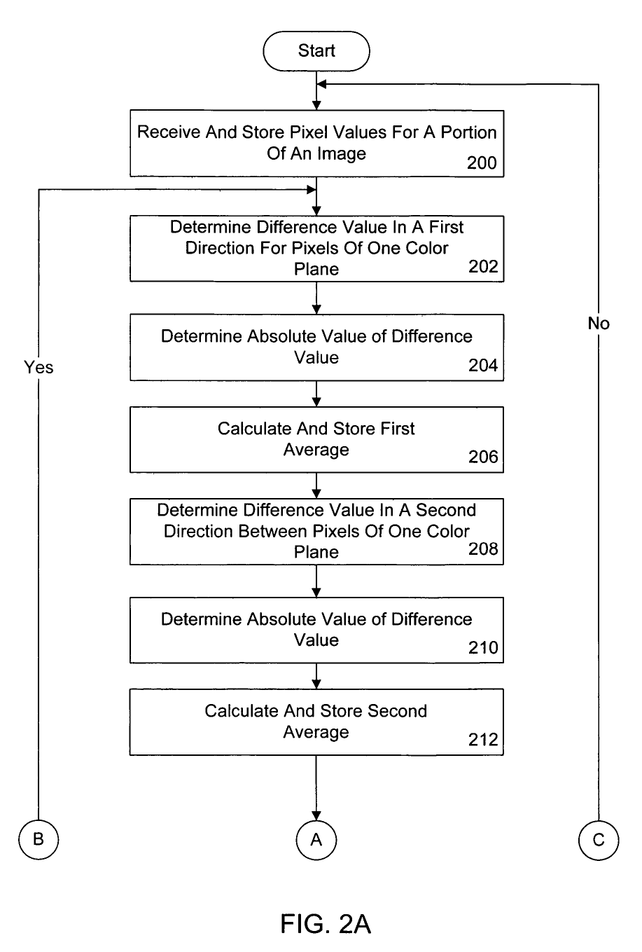

FIGS. 2A-2B depict a flowchart of a second method for image white point estimation in an embodiment in accordance with the invention. As with the embodiment of FIG. 1, a single consistent illuminant is assumed for the entire image. Other embodiments in accordance with the invention, however, are not limited to this assumption. When multiple spatially color-variant illuminants are present in an image, for example, embodiments in accordance with the invention may perform the method of FIG. 2 on sub-regions within the image to estimate each illuminant separately.

Initially, pixel values for a portion of an image are received at block 200. A difference value between two pixels in one color plane and in one direction is then determined (block 202). For example, in one embodiment in accordance with the invention, the difference value is calculated between two horizontally contiguous pixels. In another embodiment in accordance with the invention, two vertically adjacent pixels are used to determine the difference value.

The absolute value of the difference value is then obtained and included in an average of the absolute difference values and the average stored in a memory (blocks 204, 206). Although the embodiment of FIG. 2 uses the averages of absolute difference values as the statistic, other embodiments in accordance with the invention may use a different statistic of the difference values for white point estimation.

Next, at block 208, a difference value between two pixels in the same color plane but in a different direction is determined. For example, in one embodiment in accordance with the invention, the difference value determined at block 202 is between pixels in a horizontal direction and the difference value calculated at block 208 is between pixels in a vertical direction.

The absolute value of the second difference value is then obtained, as shown in block 210. The second absolute difference value is included in another average and the second average stored in a memory (block 212). A determination is then made at block 214 as to whether additional difference values need to be calculated for the pixels in the selected color plane. If so, the process returns to block 202 and continues until all desired difference values have been determined for selected pixels in the same color plane.

When all desired difference values have been determined for the pixels in the same color plane, a determination is made at block 216 as to whether there is another color plane to analyze. If so, the method moves to the next color plane (block 218) and returns to block 202. The difference values for the pixels in the next color plane are then processed.

When all desired difference values have been determined for selected pixels in all color planes, a determination is made at block 220 as to whether the entire image has been processed. If not, the method returns to block 200 and repeats until the entire image is processed. When the entire image has been analyzed, the two averages are compared at block 222.

A determination is then made at block 224 as to whether there is a significant difference between the two averages. The amount of difference between the two averages that is considered “significant” is determined by the application. A significant difference between the two averages may indicate, for example, the image is highly structured and a sufficient number of surfaces are not present in the scene for white point estimation.

If a significant difference does not exist between the two averages, white balance and color correction are performed using one or both sets of averages (block 226). If, however, a significant difference does exist between the two averages, the process passes to block 228 where a default white point is used to perform white balance and color correction.

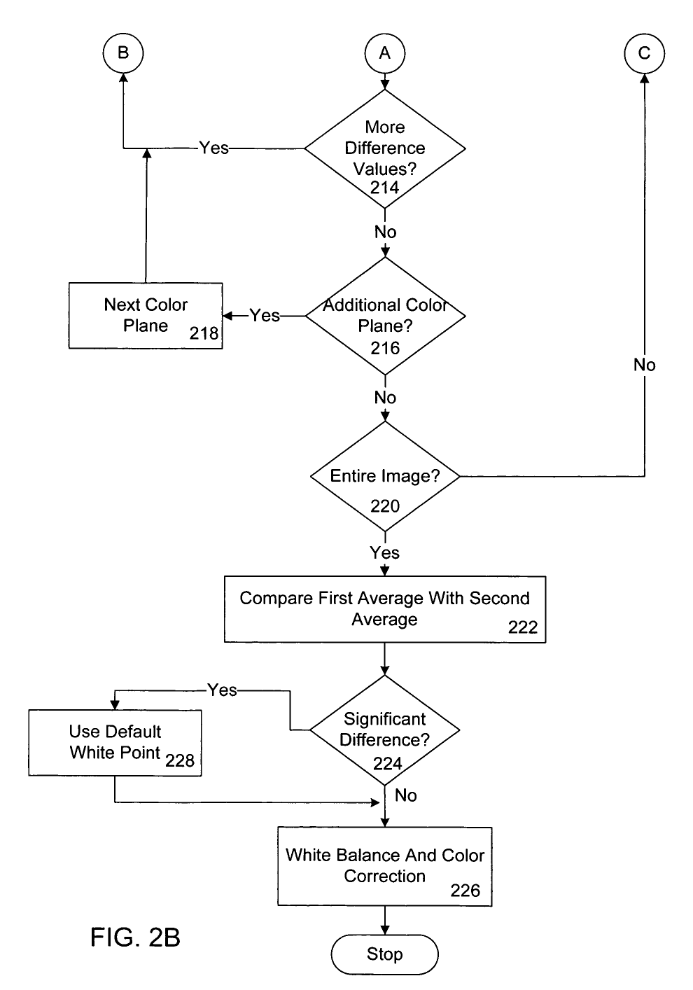

The methods illustrated in FIG. 2 and FIG. 3 use the statistics of pixel difference values to estimate white point. In some embodiments in accordance with the invention, dominant colors are colors of large continuous areas in an image, such as the sky, lawn, or a piece of clothing. Therefore, pixels with correlated colors tend to be spatially next to each other. The effect of one or more dominant colors in an image can be discounted by using pixel differences between pixels in close proximity, such as neighboring pixels, to estimate white point.

Referring to FIG. 3, there is shown a block diagram of a system that may be used to implement the methods of FIG. 1 and FIG. 2. In one embodiment in accordance with the invention, an imager (not shown) outputs pixel color values in a raster manner, where one or more horizontal lines are output at a time. Other embodiments in accordance with the invention may output pixel color values differently, such as, for example, by blocks of pixel color values.

Additionally, some digital devices, such as digital cameras, capture color using a color mosaic array on top of the sensor. This causes each pixel location to have only one color value instead of three. For example, a color mosaic array on top of an RGB sensor causes a pixel to have a red, green, or blue color value instead of red, green, and blue color values. Since the methods illustrated in FIG. 1 and FIG. 2 compute pixel difference values for pixels in the same color plane, the methods of FIG. 1 and FIG. 2 may also be employed in systems using a color mosaic array.

System 300 includes controller 302, color processing 308, buffer 306, computation circuits 310, 312, 314 and storage circuits 316, 318, 320. Controller 302 receives pixel values for an image or a portion of an image via line 304. Controller 302 stores the pixel values in buffer 306.

Color processing 308 reads the pixel data out of buffer 306 and separates the values for each color. For example, with an RGB imager, color processing 308 separates the red, green, and blue values associated with each pixel. Color processing 308 also determines the absolute difference values for a desired number of pixels. The number of absolute difference values calculated for an image or portion of an image is based on the application.

Each absolute difference value is then input into a computation circuit 310, 312, 314. With an RGB image, for example, each absolute difference value for red is input into computation circuit 310, each absolute difference value for green is input into computation circuit 312, and each absolute difference value for blue is input into computation circuit 314. Computation circuits 310, 312, 314 calculate the statistic using the pixel difference values.

In one embodiment in accordance with the invention, computation circuits 310, 312, 314 compute a running average for each color signal and store the totals in storage 316, 318, 320. When the entire image has been processed, the averages are output from each storage 316, 318, 320 and used to estimate the white point. As discussed earlier, computation circuits may calculate a different statistic using the pixel difference values in other embodiments in accordance with the invention.

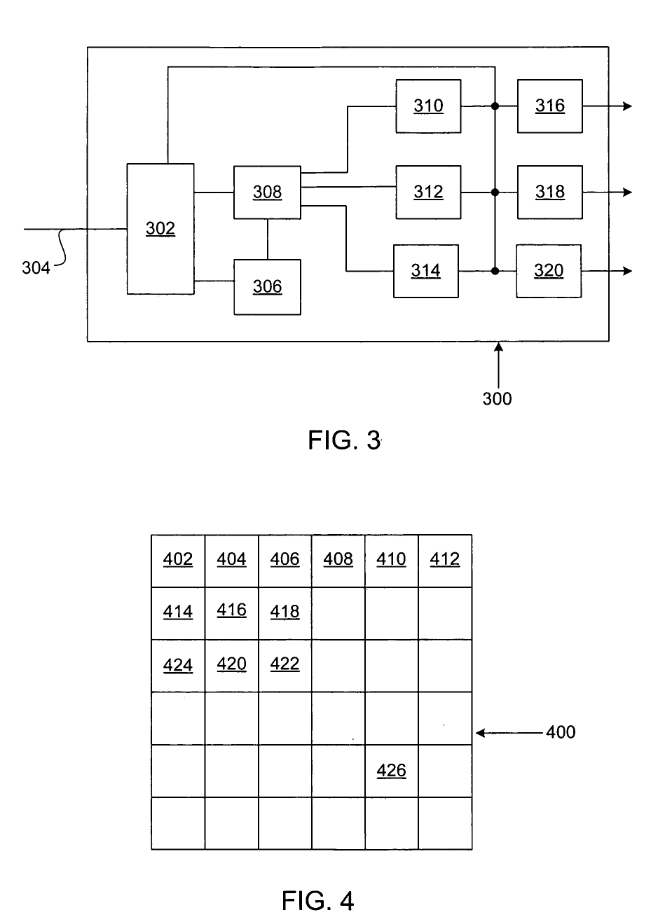

FIG. 4 is a graphical illustration of an image used to demonstrate the white point estimation methods of FIG. 1 and FIG. 2. Pixel difference values are calculated for neighboring pixels in one embodiment in accordance with the invention. Thus, for image 400 the first horizontal line of pixels are processed by first calculating a pixel difference value for pixels 402, 404. The next pixel difference value is then calculated for pixels 404, 406. This process continues until the last pixel difference value is calculated for the first horizontal line in image 400 (for pixels 410, 412). The imager then outputs the second horizontal line in image 400 and the process repeats until the entire image has been analyzed.

In another embodiment in accordance with the invention, pixel difference values are calculated in two directions, such as a horizontal and vertical direction. Thus, two pixel difference values for pixel 402 are computed; one for pixels 402, 414 and another for pixels 402, 404. Again, this process repeats for all pixels in image 400.

In yet another embodiment in accordance with the invention, four pixel difference values are computed for selected pixels. For example, pixel difference values for pixel 416 may include difference values for pixel pair 416, 414, pair 416, 418, pair 416, 420, and pair 416, 414. As another example, pixel difference values for pixel 416 may include difference values using pixel pair 416, 402, pair 416, 406, pair 416, 422, and pair 416, 424.

And finally, in another embodiment in accordance with the invention, pixel difference values are computed for non-contiguous pixels. Pixel difference values are computed between two selected pixels that have one or more pixels between the two selected pixels. For example, a pixel difference value for pixel 404 may be computed for pixels 404, 410. Alternatively, pixel difference values for pixel 402 may include a difference value for pixels 402, 406 and a pixel difference value for pixels 402, 424. And as another example, pixel difference values for pixel 422 may include a difference value for pixels 422, 426 and a pixel difference value for pixels 422, 410. Thus, the use of contiguous or non-contiguous pixels in white point estimation, as well as the locations of the selected pixels within an image, are flexible and depend upon the application.

1. A system for white point estimation for an image, comprising:
a processing circuit operable to determine a plurality of difference values between a plurality of selected pixel pairs in the same color plane; and
a computation circuit operable to calculate one or more statistics using the plurality of difference values.

2. The system of claim 1, further comprising a memory operable to store at least a portion of a plurality of pixels in the image.

3. The system of claim 1, further comprising a storage circuit operable to store the one or more statistics of the plurality of difference values.

4. A method for white point estimation for an image, comprising:
determining a plurality of difference values between a plurality of selected pixel pairs in a color plane of the image; and
calculating a statistic using the plurality of difference values.

5. The method of claim 4, further comprising repeating:
determining a plurality of difference values between a plurality of selected pixel pairs in a color plane of the image; and
calculating a statistic using the plurality of difference values for a plurality of selected pixel pairs in all color planes of the image.

6. The method of claim 5, wherein determining a plurality of difference values between a plurality of selected pixel pairs in a color plane of the image comprises determining in a first direction a plurality of difference values between a plurality of selected pixel pairs in a color plane of the image.

7. The method of claim 6, further comprising:
1) determining in a second direction a plurality of difference values between a plurality of selected pixel pairs in a color plane of the image;
2) calculating a statistic using the plurality of difference values; and
repeating 1) and 2) for a plurality of selected pixel pairs in all color planes in the image.

8. The method of claim 7, further comprising:
for each color plane, comparing the statistic associated with the first direction with the statistic associated with the second direction;
determining whether a difference exists between the two statistics; and
if a difference exists between the two statistics, determining whether the difference exceeds a predetermined value.

9. The method of claim 8, further comprising using a default white point estimation when the difference exceeds the predetermined value.

10. The method of claim 5, further comprising performing white balance and color correction using the statistic calculated for each color plane.

11. The method of claim 5, wherein determining a plurality of difference values between a plurality of selected pixel pairs in a color plane comprises determining a plurality of difference values between a plurality of selected pixel pairs in a color plane where the pixels in each pixel pair comprise contiguous pixels.

12. The method of claim 5, wherein determining a plurality of difference values between a plurality of selected pixel pairs in a color plane comprises determining a plurality of difference values between a plurality of selected pixel pairs in a color plane where the pixels in each pixel pair comprise non-contiguous pixels.
